(19) United States
(12) Patent Application Publication
(10) Pub. No.: US 2014/0011073 A1
(43) Pub. Date: Jan. 9, 2014

(54) HAND TOOL BATTERY DEVICE

(71) Applicants: Wolf MATTHIAS, Stuttgart (DE); Thorsten SEIDEL, Remseck (DE)

(72) Inventors: Wolf MATTHIAS, Stuttgart (DE); Thorsten SEIDEL, Remseck (DE)

(73) Assignee: ROBERT BOSCH GMBH, Stuttgart (DE)

(21) Appl. No.: 13/927,275

(22) Filed: Jun. 26, 2013

(30) Foreign Application Priority Data
Jun. 28, 2012 (DE) 10 2012 211 171.9

(51) Int. Cl. H01M 2/20

(52) U.S. Cl. CPC H01M 2/202; H01M 2/204; H01M 2/206
USPC 429/160

(57) ABSTRACT

A hand tool battery device having at least a first, a second, and a third battery cell as well as at least one one-piece cell connector is described. The connector electrically and conductively connects at least the first battery cell and the second battery cell. It is provided that the hand tool battery device has a flexible cell connector which electrically and conductively connects the first battery cell and the second battery cell at least to the third battery cell.

### BACKGROUND INFORMATION

A hand tool battery device having at least a first, a second, and a third battery cell as well as at least one one-piece cell connector, which electrically conductively connects at least the first battery cell and the second battery cell, has already been proposed.

### SUMMARY

The present invention is directed to a hand tool battery device having at least a first, a second, and a third battery cell as well as at least one one-piece cell connector, which electrically conductively connects at least the first battery cell and the second battery cell.

It is proposed that the hand tool battery device has a flexible cell connector which electrically conductively connects the first battery cell and the second battery cell at least to the third battery cell. A “battery cell” is in particular to be understood to mean an element which is provided to receive electrical energy, to chemically store the energy, and to electrically output the energy. The battery cells are preferably designed as lithium-based battery cells. In particular, the term “one-piece” is at least to be understood to mean that all parts of the cell connector are integrally interconnected. The cell connector is preferably at least essentially formed from a single material. The cell connector is advantageously designed as a sheet-metal element. In particular, the cell connector is manufactured using a stamping process. A “cell connector” is in particular to be understood to mean an element which, in an operating state, couples with low resistance at least two poles, preferably two plus poles or two minus poles, of different battery cells to one another. In particular, the phrase “to electrically conductively connect” is to be understood to mean that the cell connector between the at least two poles of different battery cells establishes a bridge having a resistance which is lower than 2 ohm, advantageously lower than 0.5 ohm, particularly advantageously lower than 0.2 ohm. The term “flexible” is in particular to be understood to mean that to counteract a movement in an operating state, the flexible cell connector uses at least a force, which is less than half, advantageously less than a quarter of the force which the one-piece cell connector would use to counteract this movement. The flexible cell connector is preferably provided to enable an uninterrupted movement, in particular by more than 2 mm, advantageously by more than 4 mm, particularly advantageously by more than 8 mm, of the first battery cell in relation to the third battery cell. Preferably, the one-piece cell connector and the flexible cell connector are connected to one another, in particular integrally, during a manufacture of the hand tool battery device. The term “provided” is in particular to be understood to mean specially designed and/or equipped. With the aid of the embodiment according to the present invention of the hand tool battery device, a movement of the battery cells in relation to one another may be advantageously compensated for without the risk of an electrically conductive connection being interrupted. In addition, low production costs may be achieved by using the flexible cell connector in differently constructed hand tool batteries.

In another embodiment, it is proposed that the flexible cell connector has a multi-part design, whereby an advantageous flexibility may be achieved. “Multi-part” is in particular to be understood to mean that the cell connector is composed of multiple parts connected to one another. In a state ready for operation, the parts are preferably connected to one another in a form-locked, force-fitted, and/or preferably integral manner.

Furthermore, it is proposed that the flexible cell connector has multiple litz wires, whereby a particularly advantageous flexibility may be achieved. In particular, “to have multiple litz wires” is to be understood to mean that the flexible cell connector has multiple, advantageously twisted, electrically conductive cores. Alternatively or additionally, the flexible cell connector could be designed as a flat and thus flexible belt.

Furthermore it is proposed that the one-piece cell connector and the flexible cell connector are welded to one another, whereby a particularly stable connection is made possible. In particular, “welded” is to be understood to mean that in some cases the cell connectors are heated up to above a melting point to achieve an integral connection during assembly. Alternatively or additionally, the cell connectors could be soldered.

In addition, it is proposed that the hand tool battery device includes at least one second one-piece cell connector and at least one fourth battery cell, the second one-piece cell connector connecting the third battery cell and the fourth battery cell, whereby a particularly powerful hand tool battery may be provided.

It is furthermore proposed that the flexible cell connector is electrically conductively connected to the first one-piece cell connector and the second one-piece cell connector, whereby a simple assembly is possible. In particular, the flexible cell connector is directly connected only to the first one-piece cell connector and the second one-piece cell connector.

In one advantageous embodiment of the present invention, it is proposed that at least the first battery cell and the second battery cell are interconnected in parallel, whereby a great retrievable current intensity may be achieved.

Furthermore, it is proposed that the flexible cell connector is at least essentially made of copper, whereby particularly small losses may be achieved. The phrase “to be made essentially of copper” is in particular to be understood to mean that the cell connector has more than 50%, advantageously more than 90%, of copper.

Furthermore, a method for manufacturing a hand tool battery according to the present invention is proposed, the third battery cell being shifted during assembly in relation to the first and the second battery cells, whereby an advantageous shape of the hand tool battery is constructively possible in a simple manner. An “assembly” is in particular to be understood to mean a process in which the battery cell is installed into a battery housing. In particular, “to be shifted” is to be understood to mean that a force, which moves the third battery cell in relation to the first and the second battery cells and thus deforms the flexible cell connector, is applied to the third battery cell during the installation.

### BRIEF DESCRIPTION OF THE DRAWINGS

FIG. 1 shows a hand tool battery having a hand tool battery device according to the present invention in a first sectional view.

FIG. 2 shows the hand tool battery from FIG. 1 in a second sectional view.

FIG. 3 shows the hand tool battery from FIG. 1 in a side view.

FIG. 4 shows a part of a hand tool battery in another exemplary embodiment of a hand tool battery device according to the present invention in a perspective view.

FIG. 5 shows the hand tool from FIG. 4 in a perspective view.

### DETAILED DESCRIPTION

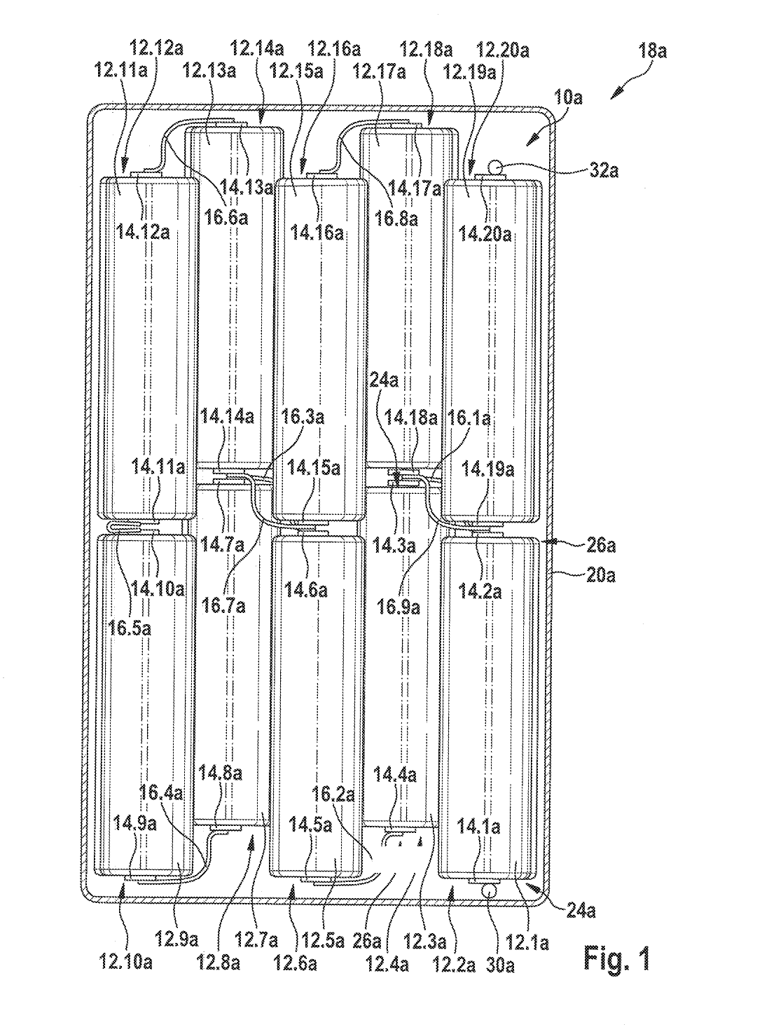

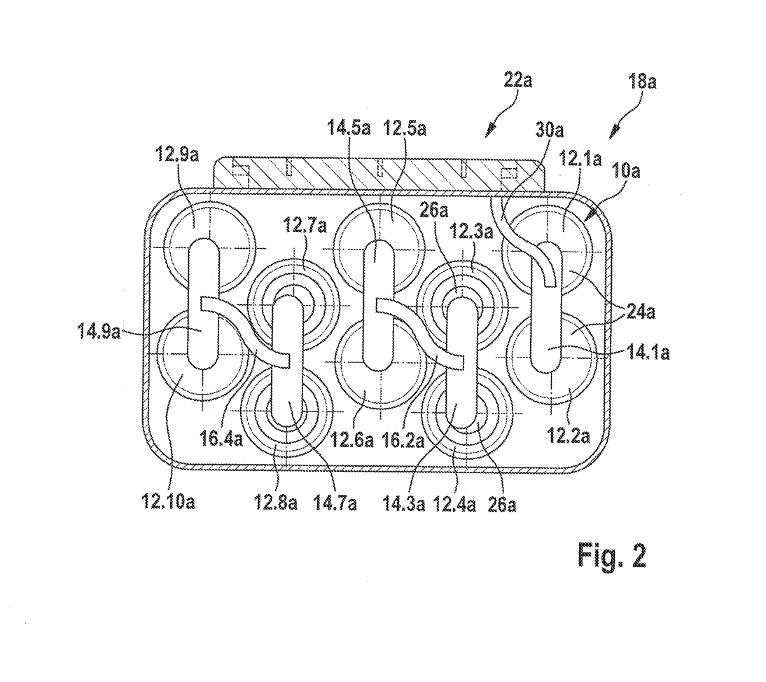

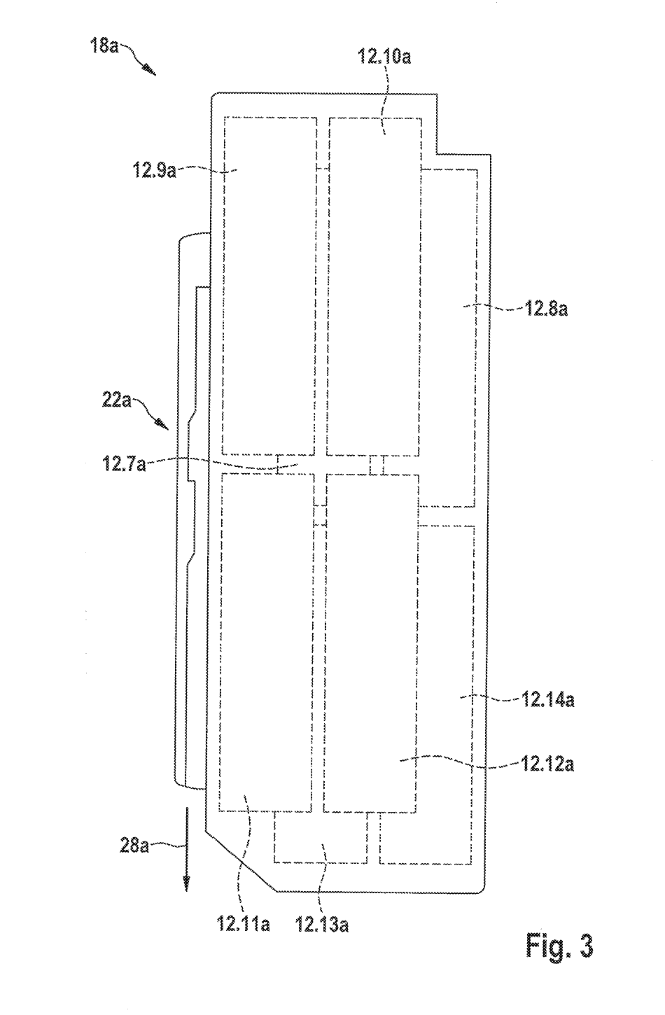

FIGS. 1 through 3 show a hand tool battery 18a having a hand tool battery device 10a according to the present invention, a battery housing 20a, a hand tool coupling element 22a, and battery electronics (not illustrated here in greater detail). Hand tool coupling element 22a is provided to mechanically and electrically connect battery housing 20a to a hand tool, which is not illustrated here in greater detail. The connection is designed in such a way that it may be detached by the user in a tool-free manner. Battery housing 20a encloses hand tool battery device 10a.

Hand tool battery device 10a includes battery cells 12.1a through 12.20a, one-piece cell connectors 14.1a through 14.20a, flexible cell connectors 16.1a through 16.9a, and a cell holder which is not illustrated here in greater detail. The cell holder fixes battery cells 12.1a through 12.20a in battery housing 20a. Battery cells 12.1a through 12.20a each have a minus pole 24a and a plus pole 26a. Minus pole 24a and plus pole 26a of battery cells 12.1a through 12.20a are situated on the opposite sides of battery cells 12.1a through 12.20a in each case. A straight line, which intersects minus pole 24a and plus pole 26a of one of battery cells 12.1a through 12.20a, is essentially oriented in parallel to a fastening device 28a of hand tool coupling element 22a. Other shapes, configurations and/or orientations of battery cells which seem to be reasonable to those skilled in the art are possible.

Hand tool battery device 10a includes twenty battery cells 12.1a through 12.20a in this exemplary embodiment. Battery cells 12.1a through 12.20a are designed as lithium-based battery cells. One-piece cell connectors 14.1a through 14.20a are made of a sheet metal. Every two of one-piece cell connectors 14.1a through 14.20a switch in parallel two of battery cells 12.1a through 12.20a in each case. A first of one-piece cell connectors 14.1a and a second of one-piece cell connectors 14.2a switch in parallel a first of battery cells 12.1a and a second of battery cells 12.2a. First cell connector 14.1a electrically conductively connects minus pole 24a of first battery cell 12.1a to minus pole 24a of second battery cell 12.2a. Second cell connector 14.2a electrically conductively connects plus pole 26a of first battery cell 12.1a to plus pole 26a of second battery cell 12.2a. A third of one-piece cell connectors 14.3a and a fourth of one-piece cell connectors 14.4a switch in parallel a third of battery cells 12.3a and a fourth of battery cells 12.4a. The other of one-piece cell connectors 14.5a through 14.20a and the other of battery cells 12.5a through 12.20a are interconnected according to this pattern. Other parallel circuits and/or series circuits of battery cells which seem to be reasonable to those skilled in the art are possible.

Flexible cell connectors 16.1a through 16.9a connect two of one-piece cell connectors 14.1a through 14.20a in each case. Here, each of one-piece cell connectors 14.1a through 14.20a is connected to exactly one of flexible cell connectors 16.1a through 16.9a. A first of flexible cell connectors 16.1a electrically conductively connects the first of one-piece cell connectors 14.1a to the second of one-piece cell connectors 14.2a. A second of flexible cell connectors 16.2a electrically conductively connects the third of one-piece cell connectors 14.3a to the fourth of one-piece cell connector 14.4a. The other of flexible cell connectors 16.5a through 16.9a and the other of one-piece cell connectors 14.5a through 14.20a are interconnected according to this pattern. Flexible cell connectors 16.1a through 16.9a thus switch in series two battery cells 12.1a through 12.20a, connected in parallel, in each case. Other series circuits of battery cells which seem reasonable to those skilled in the art are possible. Flexible cell connectors 16.1a through 16.9a are welded to two of one-piece cell connectors 14.1a through 14.20a in each case.

Flexible cell connectors 16.1a through 16.9a have a multi-part design. Flexible cell connectors 16.1a through 16.9a have multiple litz wires. The litz wires are interwoven. The litz wires are connected by welding flexible cell connectors 16.1a through 16.9a to one-piece cell connectors 14.1a through 14.20a. Flexible cell connectors 16.1a through 16.9a are made of copper. Battery cells 12.1a through 12.20a are connected to the battery electronics via cables 30a, 32a. Alternatively, cables 30a, 32a could connect battery cells 12.1a through 12.20a directly to hand tool coupling element 22a. Instead of cables 30a, 32a, hand tool battery 18a could also have flexible connectors for connecting battery cells 12.1a through 12.20a to the battery electronics and/or hand tool coupling element 22a.

During the manufacture of hand tool battery 18a, battery cells 12.1a through 12.20a, which are switched in parallel in each case, are shifted, during the assembly, in relation to other battery cells 12.1a-12.20a, which are switched in parallel. In this case, a flexible cell connector 16.1a-16.9a is deformed which switches in series these battery cells 12.1a through 12.20a, which are switched in parallel. In a state ready for operation, battery cells 12.1a through 12.20a are in a plane which is oriented perpendicularly to an axial direction of battery cells 12.1a through 12.20a; they are, for example, situated in an offset manner around a radius of battery cells 12.1a through 12.20a in a main direction of extension of one-piece cell connectors 14.1a-14.20a. Battery cells 12.1a through 12.20a, which are switched in parallel, are shifted in the axial direction in this plane in relation to battery cells 12.1a through 12.20a, which are situated adjacently and are switched in parallel. Battery cells 12.1a-12.20a which are switched in parallel and which are situated closer to hand tool coupling element 22a are offset in the axial direction in relation to battery cells 12.1a-12.20a, which are switched in parallel and which are situated farther away from hand tool coupling element 22a.

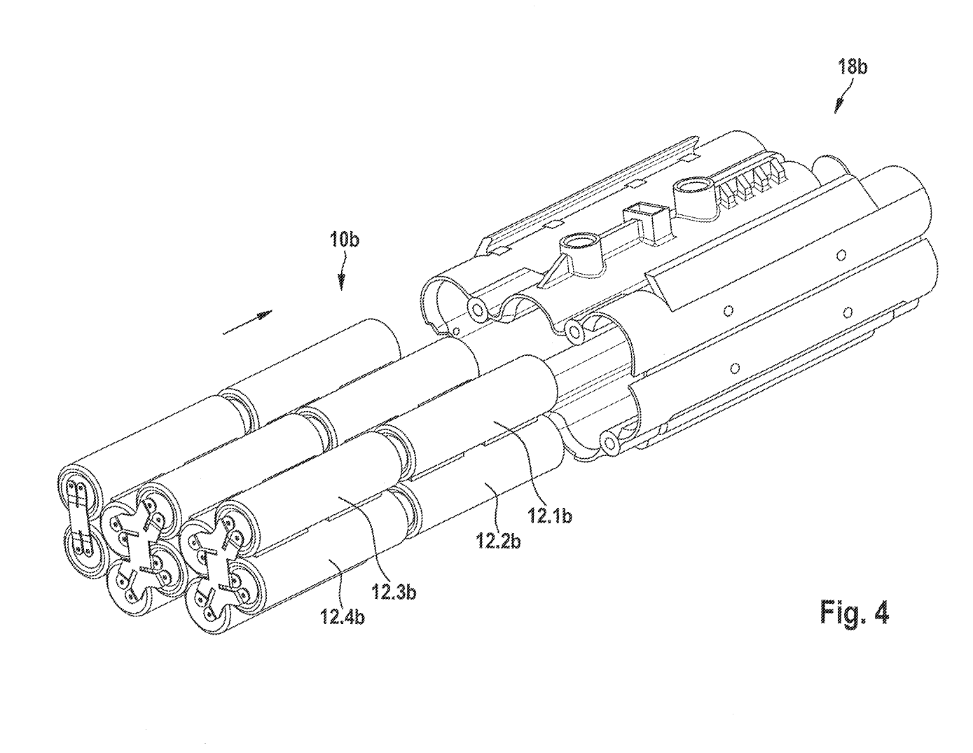

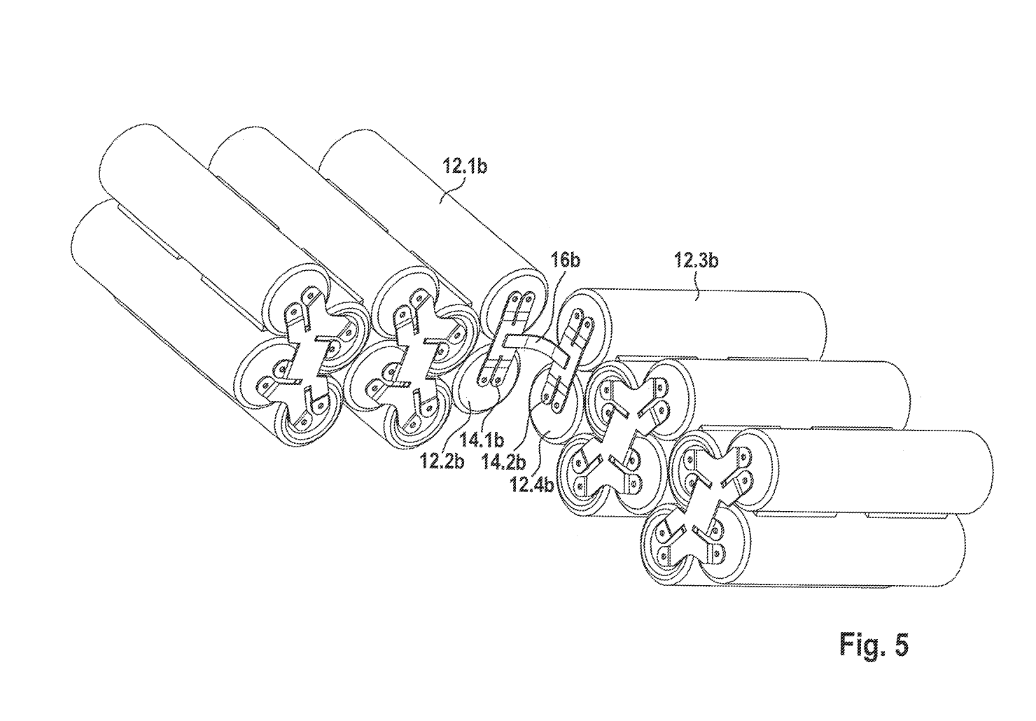

FIGS. 4 and 5 show another exemplary embodiment of the present invention. The following descriptions and drawings are essentially limited to the differences between the exemplary embodiments, it also being possible to make references with regard to identically identified components, in particular to components having identical reference numerals, basically also to the drawings and/or the description of the other exemplary embodiments, in particular of FIGS. 1 through 3. To differentiate between the exemplary embodiments, letter a is added after the reference numerals of the exemplary embodiment in FIGS. 1 through 3. In the exemplary embodiments of FIGS. 4 and 5, letter a is replaced by letter b.

FIGS. 4 and 5 show a part of a hand tool battery 18b having a hand tool battery device 10b according to the present invention. Hand tool battery device 10b includes sixteen other battery cells in addition to a first battery cell 12.1b, a second battery cell 12.2b, a third battery cell 12.3b, and a fourth battery cell 12.4b. Furthermore, hand tool battery device 10b includes a first one-piece cell connector 14.1b, a second one-piece cell connector 14.2b, and other one-piece cell connectors. First one-piece cell connector 14.1b electrically conductively connects first battery cell 12.1b and second battery cell 12.2b. First one-piece cell connector 14.1b switches in parallel first battery cell 12.1b and second battery cell 12.2b on one side. Second one-piece cell connector 14.2b electrically conductively connects third battery cell 12.3b and fourth battery cell 12.4b. Second one-piece cell connector 14.2b switches in parallel third battery cell 12.3b and fourth battery cell 12.4b on one side.

Hand tool battery device 10b includes a flexible cell connector 16b which electrically conductively connects first battery cell 12.1b and second battery cell 12.2b to third battery cell 12.3b and fourth battery cell 12.4b. Each of two of the other battery cells are switched in parallel by the other one-piece cell connectors and electrically conductively connected. Each of the two battery cells are switched in series with the other battery cells. The battery cells are shifted during an assembly in such a way that in an assembled operating state, at least two battery cells are situated one behind the other in the axial direction in each case. During an assembly, flexible cell connector 16b is bent by at least essentially 180 degrees.

What is claimed is:

1. A hand tool battery device, comprising:
at least a first battery cell, a second battery cell, and a third battery cell;
at least one one-piece cell connector that electrically and conductively connects at least the first battery cell and the second battery cell; and
a flexible cell connector that electrically and conductively connects the first battery cell and the second battery cell at least to the third battery cell.

2. The hand tool battery device as recited in claim 1, wherein the flexible cell connector has a multi-part design.

3. The hand tool battery device as recited in claim 1, wherein the flexible cell connector has multiple litz wires.

4. The hand tool battery device as recited in claim 1, wherein the one-piece cell connector and the flexible cell connector are welded to one another.

5. The hand tool battery device as recited in claim 1, further comprising:
at least one second one-piece cell connector; and
at least one fourth battery cell, wherein the second one-piece cell connector connects the third battery cell and the fourth battery cell.

6. The hand tool battery device as recited in claim 5, wherein the flexible cell connector is electrically and conductively connected to the first one-piece cell connector and the second one-piece cell connector.

7. The hand tool battery device as recited in claim 1, wherein at least the first battery cell and the second battery cell are interconnected in parallel.

8. The hand tool battery device as recited in claim 1, wherein the flexible cell connector includes copper.

9. A hand tool battery, comprising:
a hand tool battery device that includes:
at least a first battery cell, a second battery cell, and a third battery cell;
at least one one-piece cell connector that electrically and conductively connects at least the first battery cell and the second battery cell; and
a flexible cell connector that electrically and conductively connects the first battery cell and the second battery cell at least to the third battery cell.

10. A method for manufacturing a hand tool battery that includes a hand tool battery device provided with at least a first battery cell, a second battery cell, and a third battery cell; at least one one-piece cell connector that electrically and conductively connects at least the first battery cell and the second battery cell; and a flexible cell connector that electrically and conductively connects the first battery cell and the second battery cell at least to the third battery cell, the method comprising:
shifting the third battery cell during assembly in relation to the first battery cell and the second battery cell.
